(19) United States
(12) Patent Application Publication
(10) Pub. No.: US 2012/0113235 A1
(43) Pub. Date: May 10, 2012

(54) 3D GLASSES, SYSTEMS, AND METHODS FOR OPTIMIZED VIEWING OF 3D VIDEO CONTENT

(75) Inventor: Peter Shintani, San Diego, CA (US)

(73) Assignee: SONY CORPORATION, Tokyo (JP)

(21) Appl. No.: 13/252,093

(22) Filed: Oct. 3, 2011

Related U.S. Application Data
(60) Provisional application No. 61/411,007, filed on Nov. 8, 2010.

(51) Int. Cl. H04N 13/04

(52) U.S. Cl. 348/51; 348/E13.075

(57) ABSTRACT

3D glasses, 3D glasses systems, and related methods are disclosed for determining an orientation of the 3D glasses, and at least one of: indicating such to a user or adjusting disparity of the 3D content for optimizing a 3D video content viewing experience. The orientation of 3D glasses is determined by a tilt sensor or an infrared camera. A notification according to the orientation of the 3D glasses is provided to a user in the form of a visual indicator on a display, a vibration of the 3D glasses, or an audible sound. A video content device may be programmed to switch from a 3D presentation mode to a 2D presentation mode according to an orientation of the 3D glasses. Additionally, the system may be adapted to adjust image disparity to compensate for tilt.

### CROSS-REFERENCE TO RELATED APPLICATIONS

This application claims priority to U.S. Provisional Application Ser. No. 61/411,007, filed Nov. 8, 2010, titled “STABILIZED 3D GLASSES”, the entire contents of which are hereby incorporated by reference.

### BACKGROUND OF THE INVENTION

1. Field of the Invention

This invention relates to 3D glasses and related systems for viewing 3D video content. More particularly, the invention relates to 3D glasses, 3D glasses systems, and methods for determining an orientation of 3D glasses for optimizing a 3D content viewing experience.

2. Description of the Related Art

In recent years, the proliferation of television sets referred to as flat panel displays, such as liquid crystal displays (LCDs) and plasma display panels (PDPs), has rapidly advanced and created widespread attention. Moreover, recent years have seen rapid uptake of high-definition recorders and media players, thereby helping to establish a home environment where users are able to view not only high-definition broadcasts, but also high-definition packaged media. In these circumstances, flat panel displays enabling the viewing of three-dimensional (3D) stereoscopic video content are also being successively announced.

The methods for viewing 3D stereoscopic video content can be roughly classified into two types: glasses methods, which use polarizing filter glasses or shutter glasses; and naked eye methods, which use lenticular, parallax barrier, or similar methods that do not involve glasses. Among these methods, glasses methods are rapidly becoming widespread for home viewing in consideration of compatibility with two-dimensional image displays.

FIG. 1 illustrates the principle behind viewing a 3D stereoscopic video using shutter glasses.

On the display 1, the following are displayed in a time series: a first left-eye video frame or “image” L1, a first right-eye image R1, a second left-eye image L2, a second right-eye image R2, a third left-eye image L3, a third right-eye image R3, and so on, with left-eye images being displayed in alternation with right-eye images, and the sum of all images being displayed in time series collectively defining a video content.

Meanwhile, the user viewing the 3D stereoscopic video wears the shutter glasses 2. The shutter glasses 2 are supplied with a synchronization (sync) signal in the form of the vertical sync signal of the images in order of display. The shutter glasses 2 may include liquid crystal shutters with different polarizations for the left eye and right eye, respectively. The liquid crystal shutters alternately repeat the following two shutter operations in sync with the sync signal: left-eye open, right-eye closed; and left-eye closed, right-eye open. As a result, only right-eye images are input into the user's right eye, and only left-eye images are input into the user's left eye. Parallax is provided between the left-eye images and the right-eye images, and as a result of these two-dimensional images with parallax the user is able to perceive a 3D stereoscopic video.

In many cases the sync signal provided to the shutter glasses 2 is wirelessly transmitting by infrared. However, other techniques such as Bluetooth and radiofrequency have been similarly utilized.

In an alternative glasses system referred to above as a “polarizing filter glasses” system, a pair of polarizing filter glasses generally includes a first lens for a left eye having a first polarization and a second lens for a right eye having a second polarization, the second polarization being orthogonal to the first polarization. A video frame containing two similar images with parallax are simultaneously presented on a screen. A first of the two images within the frame is polarized to match the first polarization of the first lens, and a second of the two images is polarized to match the second polarization of the second lens, such that a viewer observes only the first image in the left eye and only the corresponding right image in the right eye to produce a 3D effect. Polarizing filter glasses have long been used and provide low-cost glasses for viewing 3D video content. However, when even slightly tilted by a user the perceived 3D image can become distorted with color shift and other viewing limitations.

In both shutter glasses systems and polarizing filter glasses systems, the relative positions of the display 1 and the user who views 3D stereoscopic video displayed thereon are taken to obtain a suitable relationship like that shown in FIG. 2. In other words, the suitable user viewing range 3 for viewing a 3D stereoscopic video is taken to be a fan-shaped region whose radius L is three times the vertical length l of the screen in the display 1. Consequently, the user viewing range 3 depends on the screen size of the display 1.

Moreover, the perception of 3D content is related to (i) parallax of the left and right images; (ii) interpupillary distance, or the distance between the viewer's eyes; and (iii) the viewer's position with respect to the display, with front and center at a distance of about two times the display size being optimal. Thus, according to glasses methods, the 3D viewing experience will be optimal when experienced at a position in front of the display and at a distance where the viewer's interpupillary distance and the parallax presented by the 2D frame images provides optimal disparity or distance for which the images are perceived. It should be further noted that too much disparity in the video has been shown to cause discomfort in viewers, thus a range of comfort is generally taken into consideration when video content is prepared for 3D viewing.

Consequently, because children generally have an interpupillary distance less than adults and because 3D disparity is related to interpupillary distance, the disparity observed by children is often greater than that observed by adults.

Moreover, as the viewer's head tilts to one side, the horizontal component of interpupillary distance is similarly reduced, causing a change in disparity perceived by the viewer. Thus, as a viewer's head is tilted to one side the resulting disparity effects can be magnified, potentially causing discomfort to the viewer. In extreme cases, the viewer's head may be tilted 90° to one side, such as when laying down, in which case the glasses may not effectively pass light to corresponding eyes of the viewer, and the 3D viewing experience may be ineffective.

In addition to exaggerated disparity, excessive tilt of the glasses may further cause color shifting and other viewing limitations.

Whether using active shutter glasses, or polarizing filter glasses, a viewer of 3D video content in accordance with a glasses system will observe an optimized 3D viewing experience when the glasses are maintained substantially horizontal during a viewing of the 3D video content. As such, there remains a need for 3D glasses, systems, and methods for optimizing a 3D content viewing experience by determining an orientation of 3D glasses, and notifying a user of excessive tilt of the glasses or compensating disparity for tilt.

### SUMMARY OF THE INVENTION

In accordance with the aforementioned limitations, certain improvements in the art are hereinafter disclosed.

In one embodiment, a 3D glasses system for providing a perceived 3D video content to a user in front of a two-dimensional display comprises one or more 3D glasses and a video content device. The system is adapted to determine an orientation of the 3D glasses and produce a notification to a user such that the user may correct the orientation of the 3D glasses for optimizing a 3D content viewing experience. In certain embodiments the system may be further adapted to switch from a 3D mode to a 2D mode for mitigating user discomfort due to excessive tilt.

In certain embodiments, the system is adapted to determine an orientation of the 3D glasses and adjust 3D disparity to compensate for head tilt.

In another embodiment, 3D glasses for use in a 3D glasses system comprise a tilt sensor for determining an orientation of the 3D glasses. In certain embodiments, the 3D glasses further comprise a component for notifying a user of excessive tilt. The 3D glasses can be configured either as active shutter glasses or polarizing filter glasses.

In yet another embodiment, a method for indicating an orientation of 3D glasses to a user provides an optimized 3D content viewing experience, the method includes: (i) determining an orientation of the 3D glasses, and (ii) providing a notification to the user according to the orientation of the 3D glasses.

### BRIEF DESCRIPTION OF THE DRAWINGS

FIG. 1 illustrates the principle behind viewing a 3D stereoscopic video using shutter glasses.

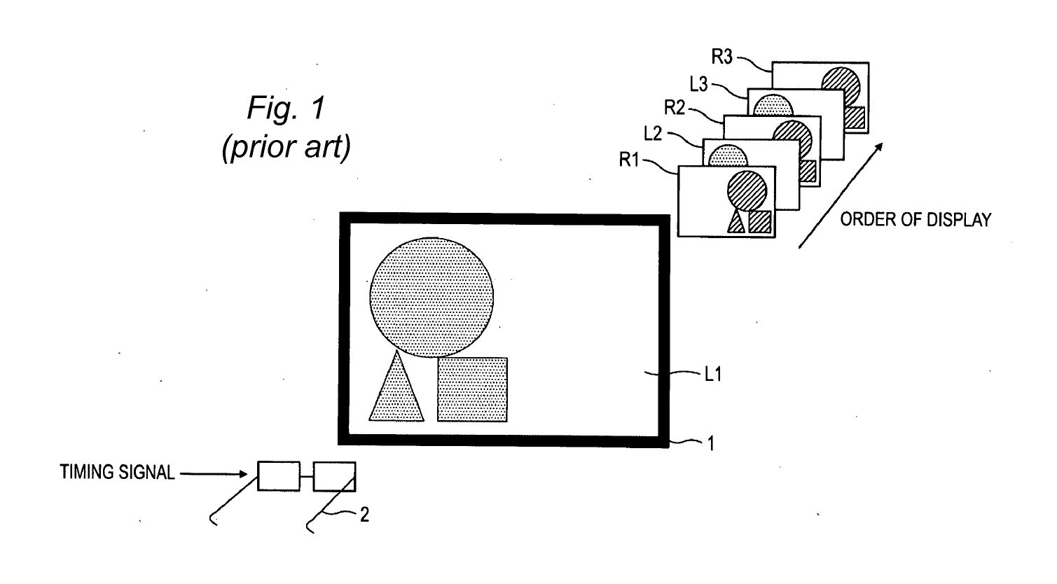

FIG. 2 illustrates a viewing range for viewing 3d stereoscopic video within a 3D glasses system.

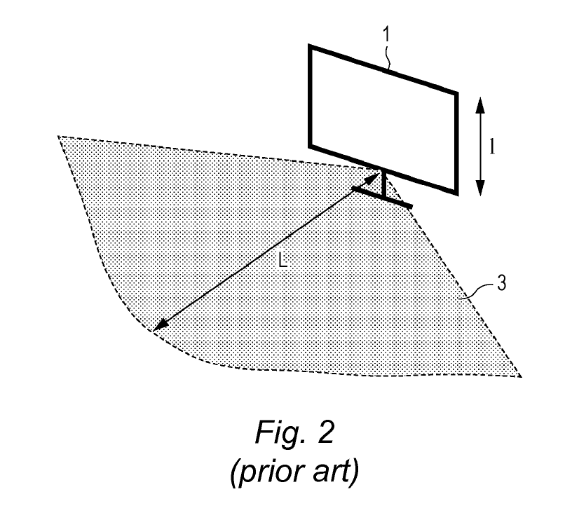

FIG. 3 illustrates a 3D glasses system adapted to determine an orientation of 3D glasses using a camera coupled to a video content device.

FIGS. 4(a-b) illustrate various screen notifications for notifying a user of a non-optimal orientation of 3D glasses, i.e. excessive head tilt.

FIGS. 5(a-b) illustrate 3D glasses comprising a tilt sensor for local determination of an orientation of the 3D glasses.

FIGS. 6(a-b) illustrate the 3D glasses of FIG. 5 further comprising a vibrating motor for providing a physical indication to a user.

FIGS. 7(a-b) illustrate the 3D glasses of FIG. 5 further comprising a speaker for providing an audible indication to a user.

FIG. 8 is a schematic representation of a method for indicating an orientation of 3D glasses to a user for optimizing a 3D content viewing experience.

FIG. 9 is a schematic representation of a general method for optimizing a 3D content viewing experience.

### DESCRIPTION OF THE PREFERRED EMBODIMENTS

With regard to viewing discomfort, exaggerated disparity, color shifting, and other 3D viewing limitations caused by head tilt when wearing 3D glasses, several embodiments are disclosed for optimizing a user's 3D viewing experience.

In a general embodiment, an orientation of 3D glasses is determined and a notification is provided to the user indicating a non-optimal orientation of the 3D glasses, i.e. excessive tilt. In this regard, the user is thus enticed to correct the orientation of the 3D glasses such that viewing discomfort is minimized, or eliminated.

In certain embodiments, 3D video content can be switched from 3D to a 2D mode if the head-tilt is extreme, for example when lying down on one's side for a ninety degree (90°) tilt from horizontal, or if the head-tilt occurs for a prolonged duration. In this regard, a viewer such as a child may not recognize discomfort due to improper viewing of 3D video content until experiencing a strong onset of discomfort related symptoms, thus it would be beneficial to recognize a potential for discomfort and adapt the system to switch to a 2D mode under certain conditions in order to mitigate viewer discomfort.

In the following paragraphs, several preferred embodiments are disclosed with reference to the appended drawings. These examples are not intended to be exhaustive in scope but rather illustrative of certain embodiments in which the invention can be practiced. Certain deviations will be readily apparent to those having skill in the art, and such deviations are intended to be within the spirit and scope of the invention as set forth in the appended claims.

3D Glasses System Adapted to Assist a User with Optimal Viewing of 3D Video Content

In certain embodiments, a 3D glasses system is adapted to assist a user with optimal viewing of 3D video content. The system is generally adapted to determine an orientation of 3D glasses worn by a user, and notify the user of such an orientation, at least when the orientation is non-optimal for viewing content within a 3D mode. The system generally comprises: a video content device and shutter glasses adapted to communicate with the video content device via a timing signal (sync signal). As described above, the sync signal is generally infrared, but can be in the form of Bluetooth, RF or other wireless signal.

The term “video content device” is generically used herein to describe any device used for viewing 3D video content, including: television (TV) sets; set top boxes, such as Blue Ray and other media players; computers; video monitors; and other related devices. Although the video content device may comprise a display itself, in certain embodiments herein the video content device may be a separate device in communication with a display, such as a set top box being connected to a flat panel liquid crystal display (LCD) via an HDMI or similar cable.

The shutter glasses further comprise a shutter for a right eye and a shutter for a left eye. The shutter glasses are adapted to perform open and close operations of the respective shutters in accordance with a timing signal synchronized with 2D video displayed on a display.

In certain alternative embodiments, polarizing filter glasses are used for the viewing of 3D video content, the system comprises one or more polarizing filter glasses and a video content device. The polarizing filter glasses generally comprise a first polarized lens adapted for positioning over a left eye, and a second polarized lens adapted for positioning over a right eye of a viewer. The second polarization of the second lens is orthogonal to the polarization of the first lens.

Of importance to the embodiments herein, the system is generally adapted to determine an orientation of the 3D glasses being worn by a viewer.

The term “3D glasses” is herein used to generally describe all types of 3D glasses, including shutter glasses and polarizing filter glasses since many of the embodiments herein can be practiced within either of: polarizing lens or shutter glasses systems.

In certain embodiments, a camera is coupled to the video content device and adapted to detect infrared being emitted from the user's eyes. In this regard, the video content device being coupled with a camera is adapted to detect an orientation of the 3D glasses since it can be inferred that the glasses are being worn over the eyes of the user. Infrared cameras are widely available, and a simple algorithm can be programmed into the video content device, or a separate device connected thereto, by those having skill in the art such that the infrared being detected can be analyzed to determine orientation of the user's eyes, and thus the orientation of the 3D glasses thereon.

In certain other embodiments, the 3D glasses may comprise one or more infrared diodes, or other light emitting diodes that can be detected by a camera coupled with a video content device, for example where infrared from the user's eyes may be reduced or undetected due to filtering through lenses of the 3D glasses.

In other embodiments, the 3D glasses may comprise a tilt sensor for determining an orientation of the 3D glasses. The tilt sensor may include an accelerometer, such as a triple-axis accelerometer, or a gyroscope (gyro). In this regard, the tilt sensor can be attached to, or embedded within, the 3D glasses. The 3D glasses comprising a tilt sensor are therefore adapted to determine an orientation thereof. However, since the orientation is locally determined, or determined within the 3D glasses, the glasses may further be adapted to communicate the orientation to the video content device via a signal referred to herein as an “orientation signal”.

With respect to shutter glasses systems, the orientation signal can be combined with the sync signal using known multiplexing methods such as time multiplexing, frequency multiplexing, and other signal combining methods.

Alternatively and with regard to 3D glasses in a general sense, the orientation signal can be transmitted separately from any sync signal using infrared, Bluetooth, or radiofrequency (RF) transmission, preferably over a unique band to avoid signal interference where a sync signal is present.

Moreover, the orientation signal can be communicated to the video content device through a wire or cable.

It is important to note that an orientation signal is not required in the embodiments where the orientation of 3D glasses is determined by camera since the orientation of the 3D glasses is determined at the video content device. Thus, power may be conserved in the embodiments wherein the orientation of 3D glasses is determined at the video content device since in these embodiments an orientation signal is not required for communicating the orientation of the 3D glasses to the video content device.

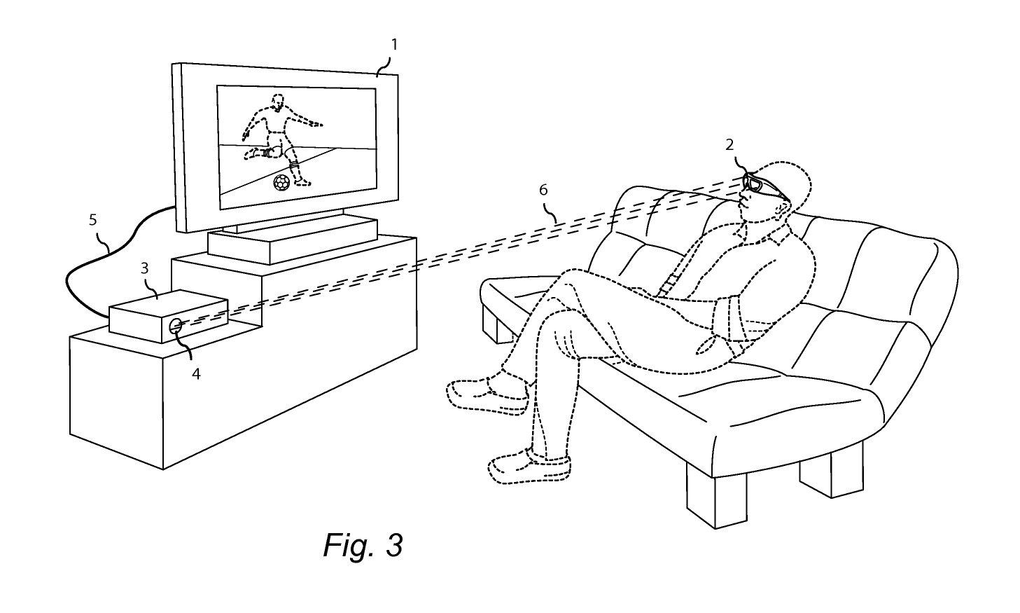

FIG. 3 illustrates a system adapted to assist a user with optimal viewing of 3D video content. The system comprises a video content device and 3D glasses worn by a viewer. The video content device comprises a set top box 3 having a camera 4 coupled therewith. The set top box is further connected to an LCD display 1 by a cable 5. A viewer wears 3D glasses 2. The camera 4 is adapted to detect infrared 6 coming from either the viewer's eyes, or one or more infrared LED's positioned on the 3D glasses. By way of infrared detection, the system is adapted to determine an orientation of the 3D glasses. The system is further adapted to continuously monitor and determine an amount of tilt associated with the viewer's present viewing state. It is important to note that the 3D glasses of the system may comprise shutter glasses or polarizing filter glasses.

Also of importance to the embodiments herein, the system is further adapted to notify the user of the orientation of the 3D glasses. In consideration of the user's viewing experience, notifications of the orientation of 3D glasses can be generally limited to instances where the orientation is non-optimal for viewing 3D video content. In this regard, a maximum tilt angle can be determined and programmed within the system, for example the maximum tilt angle may be 30° from horizontal. If the orientation of 3D glasses exceeds the maximum tilt angle, a notification can be produced for informing the user and enticing a correction.

In certain embodiments, the notification may take the form of a visual indicator including: an icon, image, text, animation, or other similar indicator for display on a display screen. The visual indicator is generally indicative of the orientation of the 3D glasses.

In certain embodiments, the visual indicator may comprise a small icon for presentation within a minimally invasive portion of the display, such as a corner of the display. Alternatively, the visual indicator can be in the form of a text within a text box for notifying the user of the present orientation of the 3D glasses. A myriad of alternative variations would be readily apparent to those having skill in the art such that a visual indicator is presented on the display for notifying a user of a non-optimal orientation of the 3D glasses.

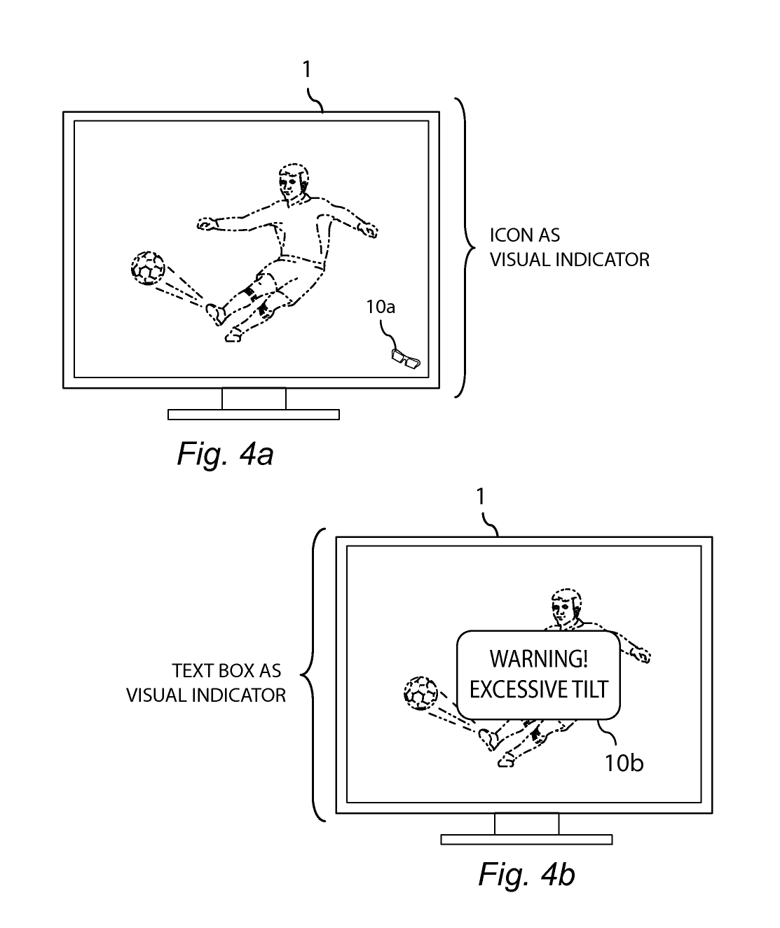

FIGS. 4(a-b) illustrate various examples of visual indicators presented on a display for notifying a user of a non-optimal orientation of 3D glasses, i.e. excessive tilt. With reference to FIG. 4a, a display 1 is adapted to display 3D video content, and a visual indicator. The visual indicator comprises an icon 10a for indicating excessive tilt to a user. The icon 10a is presented in a lower right corner of the display for minimal obstruction of the video content. Similarly, FIG. 4b illustrates a display 1 comprising a text box 10b visual indicator for indicating excessive tilt to a user. The text box as-illustrated provides a more conspicuous warning since it appears larger than the icon 10a and expands to cover more area of the display when compared to the icon 10a. Of course, a large icon could be fashioned to yield a more conspicuous visual indicator depending on manufacturer preferences.

In certain embodiments, with consideration of the viewer's experience, a more conspicuous warning, such as the illustrated text box 10b of FIG. 4b, can be presented for display only after first providing a less invasive indicator, such as the icon 10a of FIG. 4a. In this regard, a first indicator may be less invasive, and subsequent visual indicators can generally become more conspicuous according to manufacturer preferences.

### 3D Glasses for Optimized Viewing of 3D Video Content

Although a camera can be used to detect an orientation of 3D glasses as described above, certain other embodiments accomplish a similar result wherein 3D glasses comprise a tilt sensor for determining an orientation of the 3D glasses.

The tilt sensor can comprise an accelerometer, for example a triple axis accelerometer, a gyro, or a combination thereof. Moreover, the 3D glasses may comprise two or more tilt sensors for determining an orientation thereof. In this regard, the 3D glasses are adapted to locally determine an orientation based on data provided by the tilt sensor. As stated above, the orientation data can be transmitted to a video content device using infrared, Bluetooth, RF, or similar wireless methods. Alternatively, a cable can be used to couple the 3D glasses with the video content device, although at a cost of the added wire and related constraints on portability.

In the following embodiments, it is important to note that shutter glasses generally comprise a power supply, such as a battery, for powering the active liquid crystal shutters. As such, shutter glasses may be preferred vehicles for embodiments comprising a tilt sensor or other electronic components requiring power. However, it will be understood by those having skill in the art that polarizing lens glasses may be adapted with a power supply such that the following tilt-sensor embodiments may be practiced, although at an additional expense.

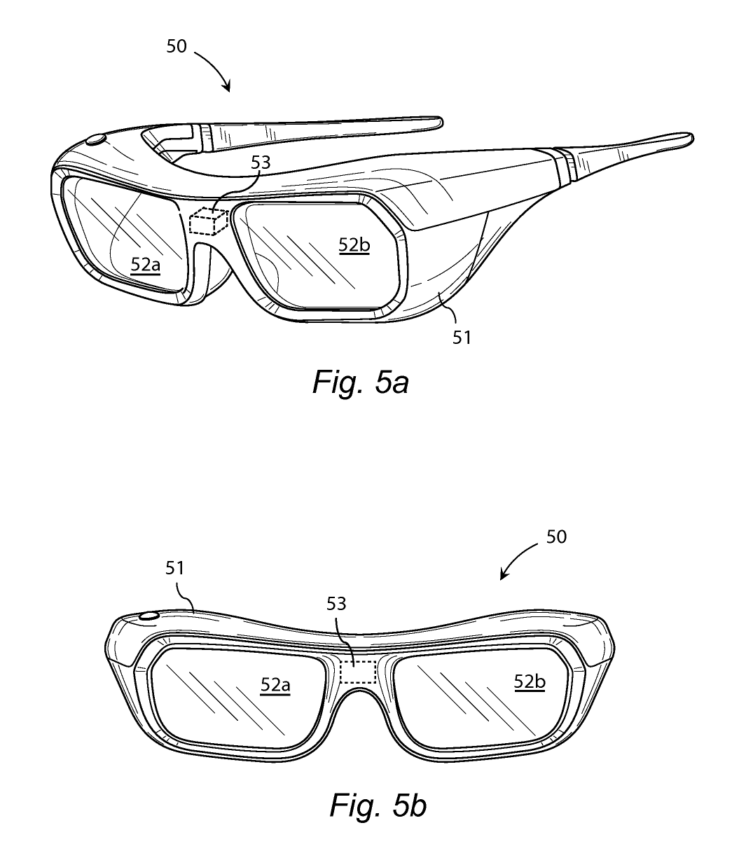

FIG. 5a illustrates a perspective view of shutter glasses 50 comprising a pair of liquid crystal shutters 52a; 52b embedded within a shutter glasses frame 51. The shutter glasses further comprise a tilt sensor 53 adapted to detect an orientation of the shutter glasses. FIG. 5b illustrates a front view of the shutter glasses of FIG. 5a.

In addition to a tilt sensor, the shutter glasses may further comprise one or more vibrating motors, speakers, or other indicator components being capable of indicating an alert to a user.

The one or more vibrating motors can be adapted to cause a vibration about the shutter glasses when the orientation is non-optimal, i.e. when the orientation of the shutter glasses exceeds a maximum tilt angle (excessive tilt).

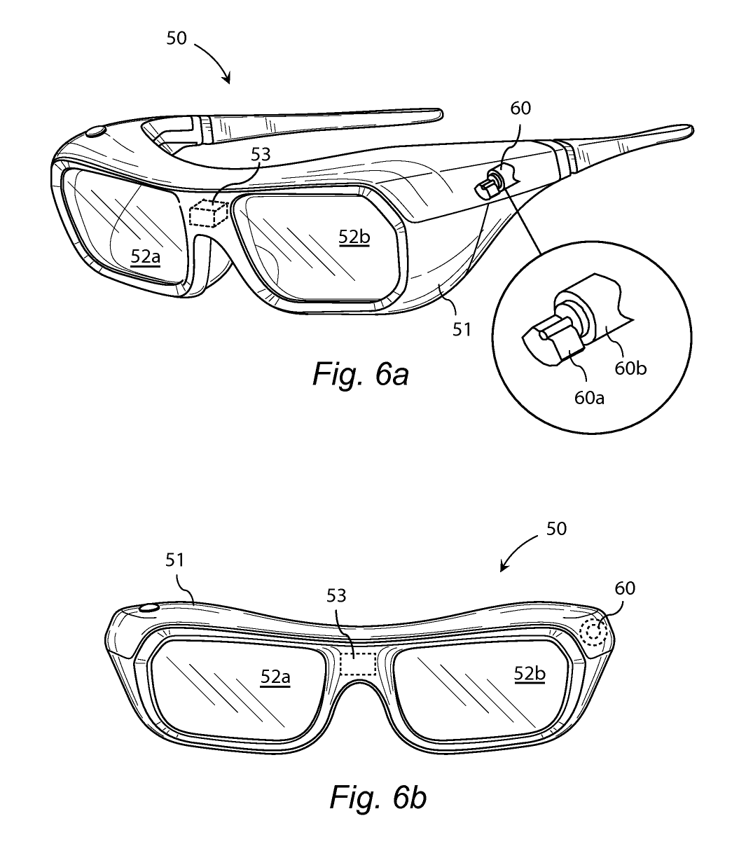

FIG. 6a illustrates a perspective view of the shutter glasses of FIG. 5, the shutter glasses 50 comprising a frame 51 and a pair of liquid crystal shutters 52a; 52b disposed within the frame. A tilt sensor 53 is attached to the shutter glasses for determining an orientation thereof. A vibrating motor is contained within the shutter glasses frame, or attached therewith. The motor is adapted to provide a vibrating notification if the orientation of the glasses exceeds a maximum acceptable tilt. The vibrating motor 60 may comprise any vibrating motor, but generally may include a rotational axis motor 60b and an offset weight 60a attached to an armature thereof. FIG. 6b further illustrates a front view of the shutter glasses according to the embodiment of FIG. 6a.

Similarly, the one or more speakers can be adapted to produce an audible tone indicating to a user the presence of excessive tilt with respect to the orientation of the shutter glasses.

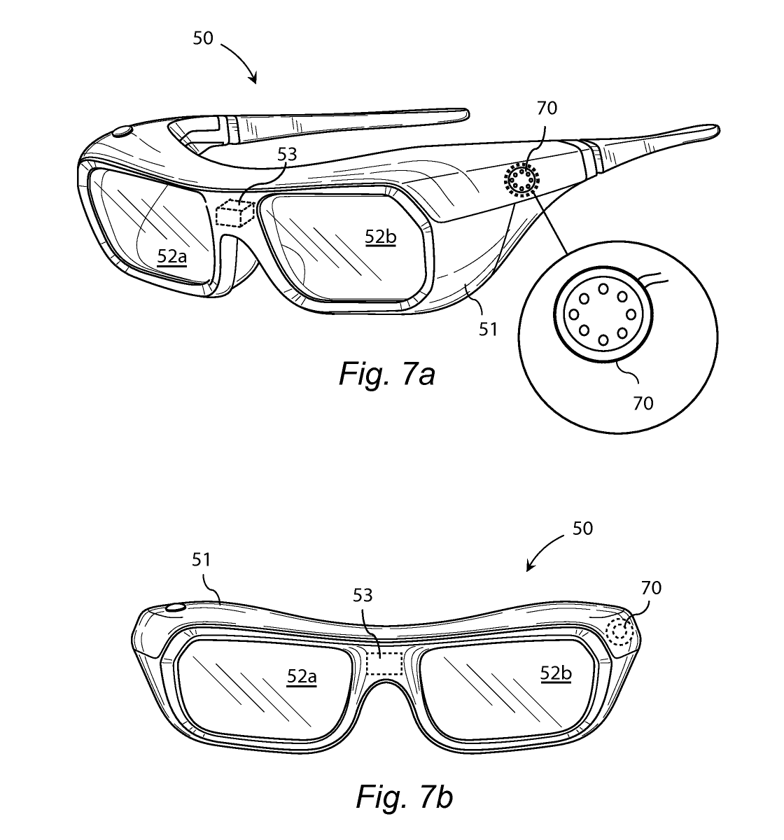

FIG. 7a illustrates a perspective view of the shutter glasses of FIG. 5, the shutter glasses 50 comprising a frame 51 and a pair of liquid crystal shutters 52a; 52b disposed within the frame. A tilt sensor 53 is attached to the shutter glasses for determining an orientation thereof. A speaker 70 is embedded within, or attached to, the shutter glasses frame. The speaker 70 is adapted to produce an audible tone for indicating excessive tilt measured by the tilt sensor.

In certain other embodiments, both a vibration and an audible tone can be produced, wherein the 3D glasses comprise at least one vibrating motor and at least one speaker.

### Method for Indicating an Orientation of 3D Glasses

According to various embodiments herein, a method is disclosed for indicating an orientation of 3D glasses to a user for optimizing a 3D content viewing experience, the method comprises: (i) determining an orientation of the 3D glasses; and (ii) providing a notification to the user according to the orientation of the 3D glasses.

The method may further comprise: providing a maximum tilt angle for acceptable viewing of 3D video content with 3D glasses. In this regard, the video content device may be programmed with a maximum tilt angle and adapted to notify a user if the 3D glasses are tilted in excess of the maximum tilt angle. Alternatively, the glasses may comprise a memory for programming the maximum tilt angle such that the glasses may locally determine tilt, assess tilt to determine whether a notification is required, and produce a notification to the user if excessive tilt is detected. Furthermore, the video content device may be adapted to switch from a 3D viewing mode to a 2D viewing mode if the 3D glasses remain tilted in excess of the maximum tilt angle for a prolonged duration, for example greater than several minutes.

In certain embodiments, the determining an orientation of the 3D glasses may be effectuated using a camera, wherein the method further comprises: detecting infrared using an infrared camera; and estimating an orientation of the 3D glasses according to the detected infrared. The infrared may be detected directly from the user's eyes, wherein the position of the left and right eyes of a user is determined from the detected infrared.

Furthermore, the determining an orientation of the 3D glasses may alternatively comprise: detecting a first and second light emitting diode using a camera, for example an infrared camera; and estimating an orientation of the 3D glasses according to a detected position of the first and second light emitting diodes. For example, the first and second light emitting diodes may be infrared light emitting diodes.

Moreover, the determining an orientation of the 3D glasses may alternatively comprise: using a tilt sensor attached to, or embedded within, the 3D glasses to determine an orientation thereof. In this regard, an orientation signal is further communicated with the video content device as described above.

In certain embodiments, the providing a notification to the user according to the orientation of the 3D glasses further comprises: displaying a visual indicator on a display, said visual indicator being indicative of the orientation of the 3D glasses.

In certain embodiments, it may be desirable to provide a constant indicator of 3D glasses orientation. Thus, an animated visual indicator may be presented on a display comprising a glasses icon which is adapted to rotate about a two-dimensional axis for indicating a real-time and continuous orientation of the 3D glasses. In this regard, as a user tilts her head, the animated visual indicator being displayed rotates according to the detected orientation of the 3D glasses.

Moreover, the providing a notification to the user according to the orientation of the 3D glasses may further comprise: producing one or more of a vibration of the 3D glasses or an audible tone for indicating to the user a non-optimal orientation of the 3D glasses.

In addition to indicating an orientation of the 3D glasses, the video content device can be programmed to switch the 3D video content to a 2D mode, for example where the orientation of the 3D glasses exceeds a maximum tilt angle, or where the 3D glasses remain tilted for an extended duration, such as for example several minutes.

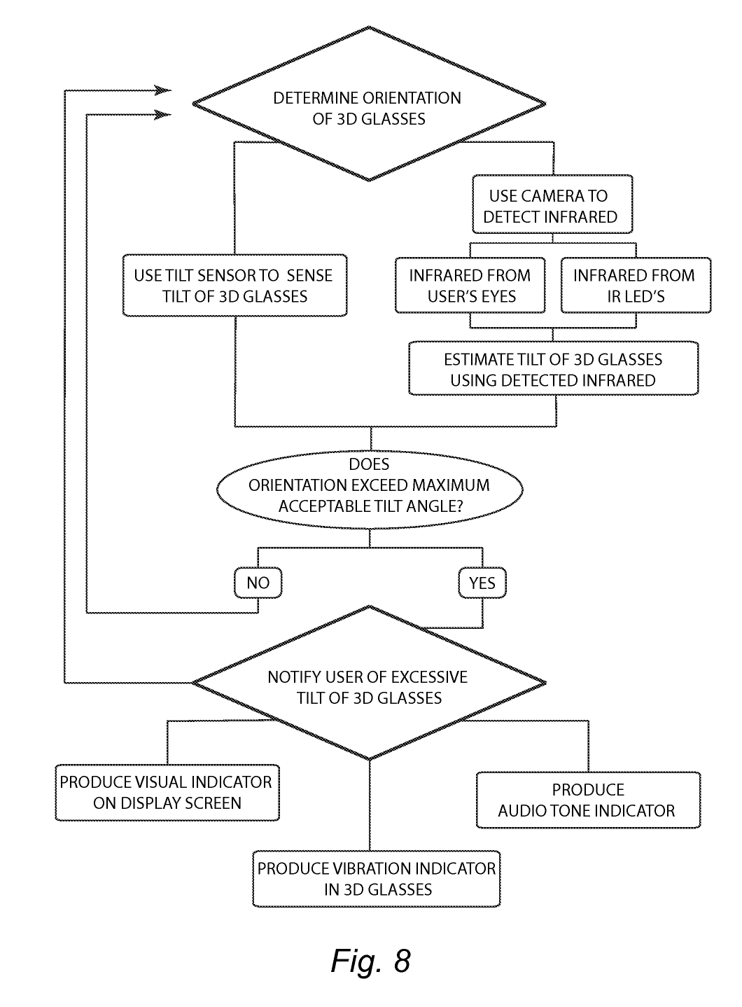

FIG. 8 illustrates a general schematic of a method according to various embodiments described herein. According to the embodiments illustrated by FIG. 8, at least one of the system or the 3D glasses is adapted to determine an orientation of the 3D glasses. The orientation of 3D glasses can be determined using a camera to detect infrared from a user's eyes, or infrared from one or more IR LED's. Alternatively, a tilt sensor can be used to indicate an orientation of the 3D glasses. Using either the camera or the tilt sensor, the tilt of the glasses is determined and compared to a threshold value, or maximum tilt angle. If the detected tilt of the 3D glasses exceeds the maximum tilt angle, a notification is provided to the user. The notification may comprise one or more of a visual indicator, vibration within the glasses, or an audio tone such that the user is informed of the excessive tilt and enticed to make a correction. The 3D glasses are continuously monitored for excessive tilt by repeating the steps described in FIG. 8.

### Disparity Adjustment for Tilt Compensation

3D video systems generally assume about 3 inches of interocular spacing for the average adult user. As the user's head tilts to one side, the horizontal component of the user's interocular spacing is reduced. Because of the reduced interocular spacing, disparity in the 3D images can be significantly exaggerated.

Thus, in another embodiment the system is adapted to compensate image disparity by reducing parallax between left and right images in a video series in correlation with the amount of tilt detected. It is important to note that the horizontal component of the user's interocular spacing is taken into consideration since the parallax in the video images is purely horizontal.

For example, the horizontal component for a 30° head tilt would yield about one half of the user's interocular distance, the sine of 30°. Due to the reduced interocular spacing, parallax in the images is similarly reduced by about half. Thus, the perceived disparity is also reduced to compensate for tilt. A simple algorithm may take into consideration the tilt angle or orientation of the 3D glasses, the interocular spacing of an average user, and parallax between images such that parallax between images may be adjusted to provide compensation in the perceived disparity during 3D viewing.

In this regard, the system can be programmed with an algorithm for adjusting parallax, and ultimately disparity, in correlation with detected tilt of the 3D glasses. Moreover, the system is adapted to dynamically adjust 3D disparity in response to the orientation of 3D glasses, thereby compensating disparity in the event of head tilt.

This compensation of disparity in view of head tilt can be provided in lieu of a notification to a user for correcting the orientation of the glasses. Alternatively, the disparity compensation can be provided in addition to a user notification.

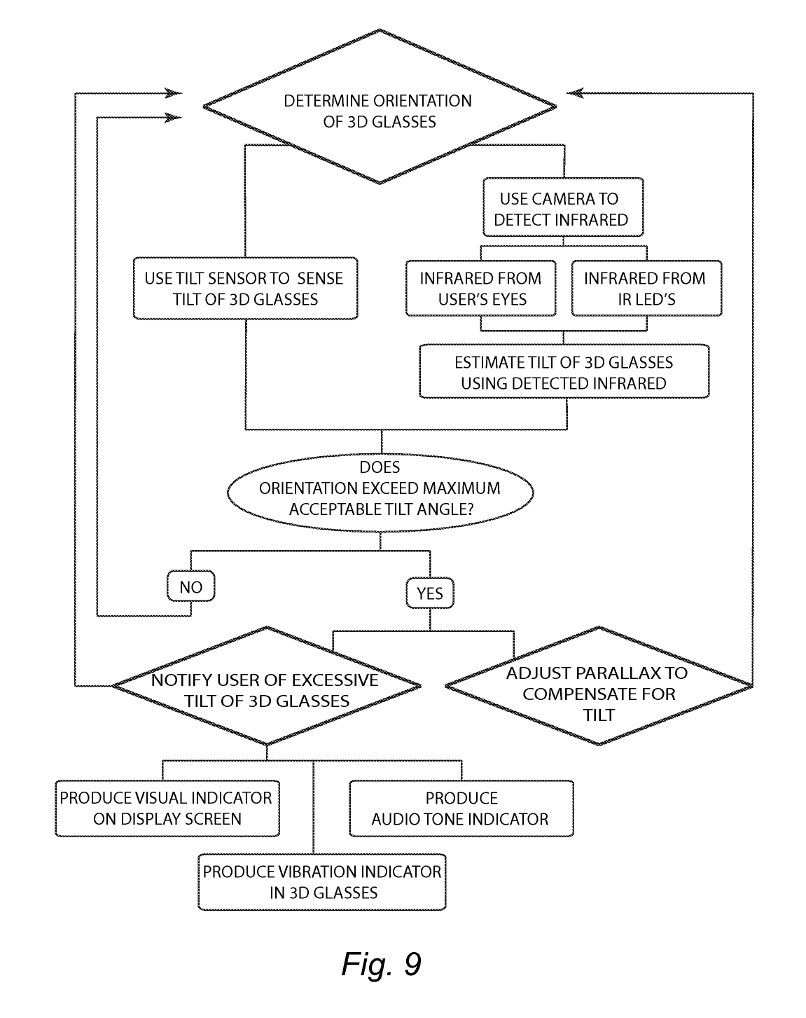

FIG. 9 illustrates a general schematic of the methods of the invention as described in FIG. 8, with the added option of adjusting parallax to compensate for head tilt such that optimal disparity is viewed based on position and orientation of the 3D glasses. In this regard, a method may comprise determining an orientation of one or more 3D glasses within a 3D glasses system, and at least one of notifying a user of excessive tilt or adjusting image parallax to compensate disparity of the 3D content.

What is claimed is:

1. A system adapted to assist a user with optimal viewing of 3D video content, the system comprising:
a video content device; and
3D glasses adapted for stereoscopic viewing of 3D content on a two-dimensional display;
at least one of said video content device and said 3D glasses being adapted to determine an orientation of the 3D glasses; and
at least one of said video content device and said 3D glasses being adapted to notify the user of excessive tilt of the 3D glasses or adjust image disparity to compensate for tilt.

2. The system of claim 1, wherein said video content device is selected from the group consisting of: a set top box, television set, computer, and a display monitor.

3. The system of claim 1, said 3D glasses further comprising a tilt sensor for determining an orientation of the 3D glasses.

4. The system of claim 3, where said tilt sensor comprises a gyro, an accelerometer, or a combination thereof.

5. The system of claim 1, said 3D glasses further comprising a vibrating motor adapted to notify the user of excessive tilt of the 3D glasses.

6. The system of claim 1, said 3D glasses further comprising a speaker adapted to notify the user of excessive tilt of the 3D glasses.

7. The system of claim 1, said video content device further comprising an infrared camera adapted to detect infrared for determining an orientation of the 3D glasses.

8. The system of claim 1, wherein said video content device is adapted to display a visual indicator on said display, said visual indicator being indicative of the orientation of the 3D glasses.

9. The system of claim 1, said video content device being programmed to switch from a 3D presentation mode to a 2D presentation mode if the orientation of the 3D glasses exceeds a maximum tilt angle.

10. 3D glasses for optimized viewing of 3D video content, comprising one of:
shutter glasses comprising a shutter for a right eye and a shutter for a left eye performing open and close operations of shutters in accordance with a timing signal synchronized with 2D video displayed on a display; or
polarizing filter glasses comprising a first polarized lens for a left eye, a second polarized lens for a right eye, wherein a polarization of the second polarized lens is orthogonal to a polarization of the first polarized lens;
characterized in that said 3D glasses further comprise:
a tilt sensor for determining an orientation of said 3D glasses; and
one or more of a vibrating motor or speaker being adapted to notify a user of excessive tilt of the 3D glasses.

11. The 3D glasses of claim 10 comprising shutter glasses, said shutter glasses being adapted to couple with a video content device and communicate an orientation of the shutter glasses.

12. The 3D glasses of claim 10, said tilt sensor comprising a gyro, an accelerometer, or a combination thereof.

13. The 3D glasses of claim 10, comprising a vibrating motor adapted to vibrate for indicating to the user an excessive tilt of the 3D glasses.

14. The 3D glasses of claim 10, comprising a speaker adapted to provide an audible tone for indicating to the user an excessive tilt of the 3D glasses.

15. A method for indicating an orientation of 3D glasses to a user for optimizing a 3D content viewing experience, the method comprising:
determining the orientation of 3D glasses; and at least one of:
providing a notification to the user according to the orientation of the 3D glasses, or
adjusting image disparity to compensate for tilt.

16. The method of claim 15, further comprising:
providing a maximum tilt angle for acceptable viewing of 3D content; and
switching from a 3D mode to a 2D mode if the 3D glasses exceed the maximum tilt angle.

17. The method of claim 15, said determining an orientation of the 3D glasses further comprising:
using an infrared camera to detect infrared emitted from the user's left eye and right eye or infrared emitted from the 3D glasses; and
estimating the orientation of the 3D glasses according to the detected infrared.

18. The method of claim 15, said determining an orientation of the 3D glasses further comprising:
using a tilt sensor to determine the orientation of 3D glasses; and
communicating said orientation of the 3D glasses to a video content device.

19. The method of claim 15, said providing a notification to the user according to the orientation of the 3D glasses further comprising:
displaying a visual indicator on a display, said visual indicator being indicative of the orientation of the 3D glasses.

20. The method of claim 15, said providing a notification to the user according to the orientation of the 3D glasses further comprising:
producing one or more of: a vibration of the 3D glasses or an audible tone for indicating to the user an excessive tilt of the 3D glasses.
